(19) United States
(12) Patent Application Publication
(10) Pub. No.: US 2016/0278575 A1
(43) Pub. Date: Sep. 29, 2016

(54) FAST TOASTING TOASTER AND CONTROL METHOD THEREOF

(71) Applicant: SHENZHEN CRASTAL TECHNOLOGY CO., LTD, Shenzhen, Guangdong Province (CN)

(72) Inventors: George Mohan Zhang, Shenzhen, Guangdong Province (CN); Faxi Huang, Shenzhen, Guangdong Province (CN); Peng Chen, Shenzhen, Guangdong Province (CN); Chuanluan Pan, Shenzhen, Guangdong Province (CN); Tao Li, Shenzhen, Guangdong Province (CN); Jianping Cai, Shenzhen, Guangdong Province (CN)

(73) Assignee: SHENZHEN CRASTAL TECHNOLOGY CO., LTD., Shenzhen, Guangdong Province (CN)

(21) Appl. No.: 14/778,094

(22) PCT Filed: Apr. 10, 2014
(86) PCT No.: PCT/CN2014/075023

§ 371 Date: Sep. 18, 2015

(30) Foreign Application Priority Data
Dec. 23, 2013 (CN) 201310723944.7

(51) Int. Cl. A47J 37/08

(52) U.S. Cl. CPC A47J 37/0807

(57) ABSTRACT

A fast toasting toaster and a method for control the same are disclosed. The fast toasting toaster comprises a machine core assembly, a sliding rack assembly, a heating tube assembly, and a housing fixed onto a base, the mechanism core assembly comprising a front side plate, a side plate, and a rear side plate, the front side plate, the side plate and the rear side plate being fixed and coupled to form the machine core and then being fixed onto the base, the heating tube assembly being fixed onto the front side plate and the rear side plate and being positioned between the front side plate and the rear side plate, the sliding rack assembly comprising a sliding rack and a toast rack fixed onto the sliding rack.

### TECHNICAL FIELD

The present invention relates to a toaster, and in particular, relates to a fast toasting toaster and a method for controlling the same.

### BACKGROUND

A toaster in the prior art generally provide a 900 W heating power for toasting two pieces of bread, which nominally advertising its maximum power of 1100 W to fast toasting the bread. As we know, a very great power of the heating body is desired for the purpose of less time consumption and fast toasting. The toaster available from the market generally employs two types of heating elements: heating wires and heating tubes. When heating wires are employed as the heating element, the bread is baked uniformly and evenly, but due to the limit of the surface load of the heating wires, the power of a toaster capable of toasting two pieces of bread is 900 W, and the maximum power thereof may reach 1100 W. If the heating tubes are employed, the toasting power of the heating element is significantly improved. However, since the heat energy of the heating tubes is concentrated, the bread toasting is uneven or non-uniform if the heating tubes are close to the bread during the toasting.

### SUMMARY

One objective of the present invention is to provide a fast toasting toaster which provides a high power and an increased heating capacity, quickly bakes breads, and solves the problem of uneven bread toasting.

Another objective of the present invention is to provide a method for controlling a fast toasting toaster, which provides a high power and an increased heating capacity, quickly bakes breads, and solves the problem of uneven bread toasting.

One objective of the present invention is achieved by designing a fast toasting toaster, comprising a machine core assembly, a sliding rack assembly, a heating tube assembly, and a housing fixed onto a base, the mechanism core assembly comprising a front side plate, a side plate, and a rear side plate, the front side plate, the side plate and the rear side plate being fixed and coupled to form the machine core and then being fixed onto the base, the heating tube assembly being fixed onto the front side plate and the rear side plate and being positioned between the front side plate and the rear side plate, the sliding rack assembly comprising a sliding rack and a toast rack fixed onto the sliding rack, wherein: a drive assembly is arranged, the drive assembly comprising a motor and a drive mechanism, the motor driving the sliding rack assembly to move upwards and downwards through the driving mechanism.

Further, an isolation mesh frame assembly is fixed onto the sliding rack; the toast rack is positioned in the isolation mesh frame assembly; the sliding rack is positioned on an outer side of the front side plate of the machine core assembly; and the toast rack and the insulation mesh frame assembly are positioned in a bread toasting slot of the machine core, wherein the isolation mesh frame assembly comprises an isolation mesh, a clamping spring, and an inverted semi-cutaway angle steel, the isolation mesh and the clamping spring being arranged in the mesh frame, the inverted semi-cutaway angle steel for guiding the isolation mesh being fixed onto an inner side face of the front side plate.

Further, the heating tube assembly comprises a heating tube bracket and a heating tube, the heating tube being respectively fixed onto the front side plate and the rear side plate through the heating tube bracket and being positioned between the front side plate and the rear side plate and on two sides of the roast rack and the isolation mesh frame assembly fixed onto the sliding rack.

Further, a frame of the isolation mesh frame assembly is formed through fixing and coupling of a front clamping plate, a side clamping plate and a rear clamping plate; the isolation mesh frame assembly is fixedly coupled to the sliding rack through a top-bottom coupling plate; and the isolation mesh is positioned in the mesh frame and is movably coupled to the mesh frame.

Further, upper portions of the front clamping plate and the rear clamping plate are respectively provided with a guiding groove of the isolation mesh, two ends of an isolation mesh upper horizontal bar being respectively positioned in the guiding groove; and lower portions of the front clamping plate and the rear clamping plate are respectively provided with an isolation mesh hole, two ends of an isolation lower horizontal bar being respectively positioned in the isolation mesh hole; a lower middle portion of the side clamping plate is further provided with an isolation mesh limiting pad, the limiting pad being provided with a limiting hole; and a vertical steel rope at the center of the isolation mesh is inserted into the limiting hole.

Further, an inverted U-shaped clamping spring is fixed onto an upper flanging of the front clamping plate, two downwardly extended legs of the inverted U-shaped clamping spring respectively abutting against outer sides of the isolation mesh upper horizontal bar.

Further, an end of the front clamping plate from which the isolation mesh upper horizontal bar extends corresponds to an upright-side outer side vertical direction of the inverted semi-cutaway angle steel in terms of position.

Further, an upright shaft support is fixed onto a front end of the machine core assembly; an upright shaft is fixed between the upright shaft support and the base; the sliding rack is slidably coupled to the upright shaft; and a front end face of the sliding rack is provided with a guiding groove.

Further, the drive assembly further comprises a motor stand, a lower limit switch, an upper limit switch and the motor that are fixed onto the motor stand; the drive mechanism comprises a rocker arm and a trolley wheel; the rocker arm is fixed onto an output shaft of the motor; the trolley wheel is hinged to the rocker arm; the trolley wheel is positioned in the guiding groove arranged on the front end face of the sliding rack and slidably coupled to the sliding rack; and the motor stand is fixed onto the base.

Another objective of the present invention is achieved by designing a method for controlling a fast toasting roaster, comprising the following steps:

A. configuring a toasting color selection button in a control circuit, wherein toasting colors are set by using the number of clockwise and counterclockwise rotations of the motor as a cycle, or toasting colors are distinguished based on several different cycles within an accomplishment time duration;

B. after the control circuit detects a start signal, performing initialization, and detecting a control signal and determining a toasting colors set for the toaster by the control circuit;

C. controlling, by the control circuit, a heating tube to be powered on and start heating, whereupon the toaster enters a bread toasting state;

D. controlling, by the control circuit, a motor to clockwise rotate;

E. after the control circuit detects a close signal of a lower limit switch, controlling, by the control circuit, the motor to stop rotating, with a pause of half a second;

F. controlling, by the control circuit, the motor to counterclockwise rotate, and starting timing, with a pause of half a second when the motor rotates to a predetermined time;

G. controlling, by the control circuit, a motor to clockwise rotate;

H. determining, by the control circuit, whether the number of cycles defined for motor rotation of a set toasting color, or the accomplishment time is reached;

I. if the number of cycles of motor rotation is less than the number of cycles defined for a set toasting color or the accomplishment time is not reached, returning to step F; if the number of cycles of motor rotation is equal to the number of cycles defined for a set toasting color or the accomplishment time is reached, controlling, by the control circuit, the motor to counterclockwise rotate; and when the upper limit switch is closed, controlling, by the control circuit, the heating tube to stop heating, whereupon the motor stops rotating and the toasting cycle is terminated; and

L. if the control circuit detects a stop signal, controlling, by the control circuit, the motor to counterclockwise rotate; and when the upper limit switch is closed, controlling, by the control circuit, the heating tube to stop heating, whereupon the motor stops rotating and the toasting cycle is terminated.

According to the present invention, a quartz heating tube having a high heating efficiency is employed as a heating element, and during the toasting process, a new bread holding structure is employed and the bread is controlled via program control to move within a predetermined range, such that the bread is uniformly heated. This not only fast bakes the bread, but also evenly bakes the bread slices, thereby achieving a better and fast effect.

### BRIEF DESCRIPTION OF THE DRAWINGS

FIG. 1 is a schematic view of one preferred embodiment of the present invention;

FIG. 2 is an A-A schematic view taken when an isolation mesh frame as illustrated in FIG. 1 is arranged at an upper portion of a machine core;

FIG. 3 is a schematic view taken when a sliding rack is arranged on the upper portion of the machine core according to a preferred embodiment of the present invention;

FIG. 4 is a schematic view taken when the sliding rack slides downwards according to a preferred embodiment of the present invention;

FIG. 5 is a schematic view taken when the isolation mesh frame is arranged at a highest position when toasting according to a preferred embodiment of the present invention;

FIG. 6 is a schematic view of a corresponding position of the sliding rack as illustrated in FIG. 5;

FIG. 7 is a schematic view taken when the isolation mesh frame is arranged at a lowest position when toasting according to a preferred embodiment of the present invention; and

FIG. 8 is a schematic view of a corresponding position of the sliding rack as illustrated in FIG. 7.

### DETAILED DESCRIPTION

The present invention is further described with reference to specific embodiments.

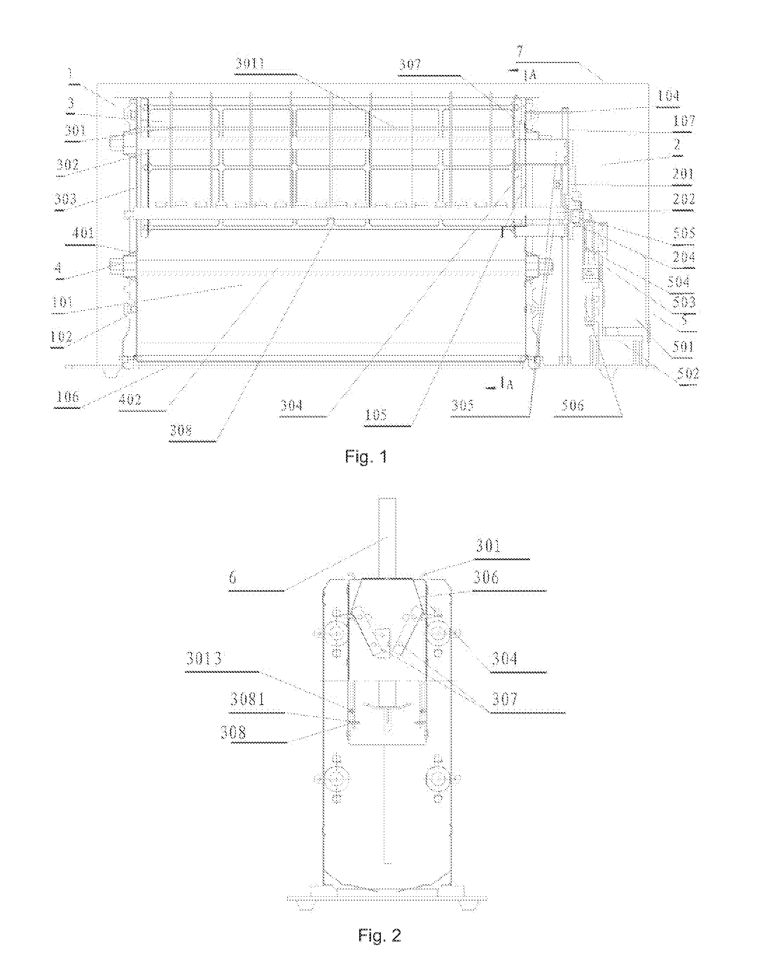

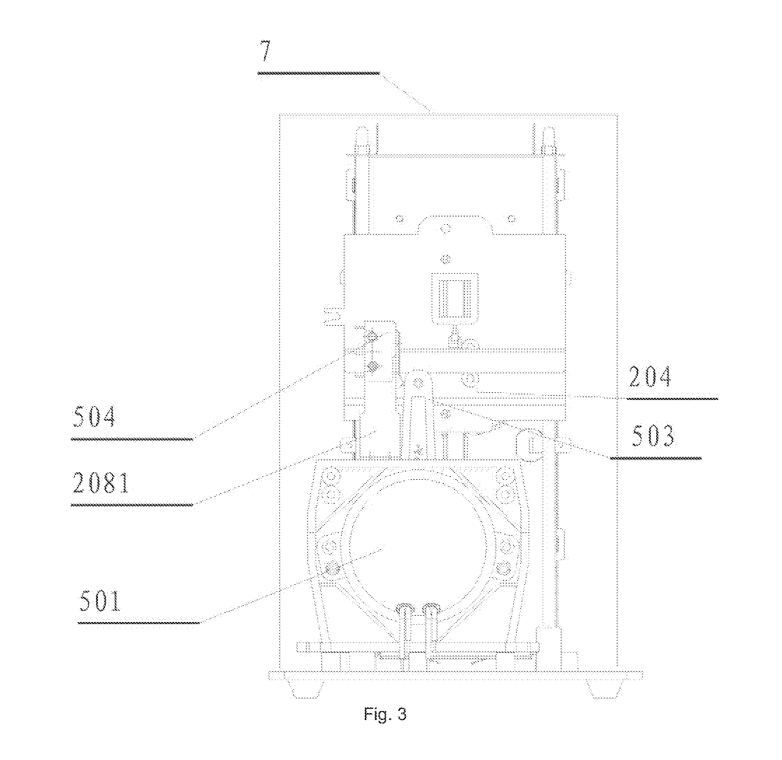

As illustrated in FIG. 1, FIG. 2 and FIG. 3, a fast toasting toaster comprises: a mechanism core assembly 1, a sliding rack assembly 2, a drive assembly 5, and a housing 7 fixed onto a base 106. The mechanism core assembly 1 comprises a front side plate 105, a side plate 101, and a rear side plate 102, wherein the front side plate 105, the side plate 101 and the rear side plate 102 are fixed and coupled to form the machine core and then are fixed onto the base 106. The heating tube assembly 4 is fixed onto the front side plate 105 and the rear side plate 102 and is positioned between the front side plate 105 and the rear side plate 102. The sliding rack assembly 2 comprises a sliding rack 201 and a toast rack 202 fixed onto the sliding rack 201. An isolation mesh frame assembly 3 is fixed onto the sliding rack 201. The toast rack 202 is positioned in the isolation mesh frame assembly 3. The sliding rack 201 is positioned on an outer side of the front side plate 105 of the machine core assembly 1. The toast rack 202 and the insulation mesh frame assembly 3 are positioned in a bread toasting slot of the machine core assembly 1. An isolation mesh 301 and a clamping spring 306 are arranged in the mesh frame of the isolation mesh frame assembly 3, wherein the isolation frame 301 is movably coupled to the isolation mesh frame assembly 3. An inverted semi-cutaway angle steel 307 for guiding the isolation mesh 301 is fixed onto an inner side face of the front side plate 105. The sliding rack assembly 2 is driven by the drive assembly 5 to move upwards and downwards along an upright shaft 7.

The heating tube assembly 4 comprises a heating tube bracket 401 and a heating tube 402, wherein the heating tube 402 is respectively fixed onto the front side plate 105 and the rear side plate 102 through the heating tube bracket 401, and is positioned between the front side plate 105 and the rear side plate 102 and on two sides of the roast rack 202 and the isolation mesh frame 3 assembly fixed onto the sliding rack 201. According to this embodiment, a quartz heating tube achieving fast heating and having a high heating efficiency is employed, generally two heating tubes, and a stainless steel heating tube or other types of heating tubes may also be employed.

A frame of the isolation mesh frame assembly 3 is formed through fixing and coupling of a front clamping plate 304, a side clamping plate 302 and a rear clamping plate 302; the isolation mesh frame assembly 3 is fixedly coupled to the sliding rack 201 through a top-bottom coupling plate 305; and the isolation mesh 301 is positioned in the mesh frame and is movably coupled to the mesh frame. The isolation mesh is generally comprised of several vertical steel wires and more than two horizontal steel wires via welding, thereby forming a mesh shape, which is used to hold the bread during toasting of the bread, such that the bread is disposed at the center of the bread toasting slot. In addition, the isolation mesh further achieves the effect of isolating the bread from the heating element of the toaster, such that a suitable distance is maintained between the bread and the heating element. As such, the bread may be baked evenly and uniformly.

Upper portions of the front clamping plate 301 and the rear clamping plate 303 are respectively provided with a guiding groove 3012 of the isolation mesh 301, wherein two ends of an isolation mesh upper horizontal bar 3011 are respectively positioned in the guiding groove 3012; and lower portions of the front clamping plate 304 and the rear clamping plate 303 are respectively provided with an isolation mesh hole 3014, wherein two ends of an isolation lower horizontal bar 3013 being respectively positioned in the isolation mesh hole 3014.

A lower middle portion of the side clamping plate 302 is further provided with an isolation mesh limiting pad 308, wherein the limiting pad 308 is provided with a limiting hole 3081; and a vertical steel rope at the center of the isolation mesh 301 is inserted into the limiting hole 3081, such that the isolation frame 301 is located and fails to move forwards and backwards.

Two holes are arranged onto an upper flanging of the front clamping plate 304, and two legs of an inverted U-shaped clamping spring 306 pass through the two holes and fixed on the upper flanging of the front clamping plate 304, wherein the two downwardly extended legs of the inverted U-shaped clamping spring 306 respectively abut against outer sides of the isolation mesh upper horizontal bar 3011. The two downwardly extended legs of the inverted U-shaped clamping spring 306 presses the outer sides of the isolation mesh upper horizontal bar 3011, such that the isolation mesh 301 is constantly subject to a force approaching towards the toast rack 202, that is, the bread toasting center. Accordingly, when the bread 6 is placed into the bread toasting slot, the bread 6 can be placed at the center of the bread toasting slot, such that two sides of the bread 6 are evenly and uniformly baked when the bread is being baked.

An end of the front clamping plate 301 from which the isolation mesh upper horizontal bar 3011 extends corresponds to an upright-side outer side vertical direction of the inverted semi-cutaway angle steel 307 in terms of position. When the sliding rack 201 moves upwards, left and right isolation mesh upper horizontal bars 3011 just abut against upright-side outer sides of the inverted semi-cutaway angle steel 307, which, as the sliding rack 201 continues moving upwards, drives the isolation mesh 301 and the isolation mesh frame 3 fixed onto the sliding rack 201 to moves upwards. In this case, the isolation mesh 301 is distracted by the inverted semi-cutaway angle steel 307, such that the isolation mesh 301 is absolutely opened, and a user can conveniently takes out the baked bread.

An upright shaft support 104 is fixed onto a front end of the machine core assembly 1; an upright shaft 107 is fixed between the upright shaft support 104 and the base 106; and a front end face of the sliding rack 201 is provided with a guiding groove 204.

The drive assembly 5 further comprises a motor stand 502, a lower limit switch 506, an upper limit switch 504 and the motor 501 that are fixed onto the motor stand 502; a rocker arm 503 is fixed onto an output shaft of the motor 501; a trolley wheel 505 is hinged to the rocker arm 503; the trolley wheel 505 is positioned in the guiding groove 204 arranged on the front end face of the sliding rack 201 and is slidably coupled to the sliding rack 201; and the motor stand 502 is fixed onto the base 106.

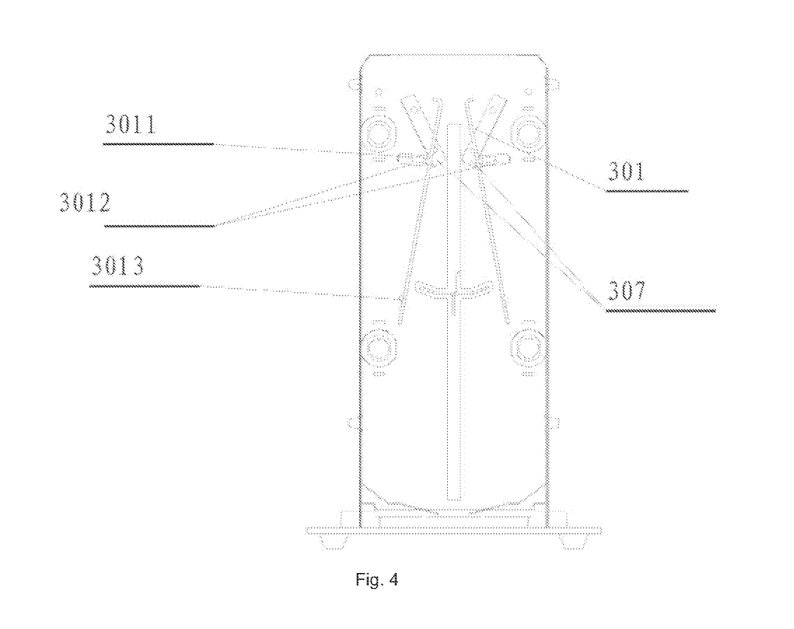

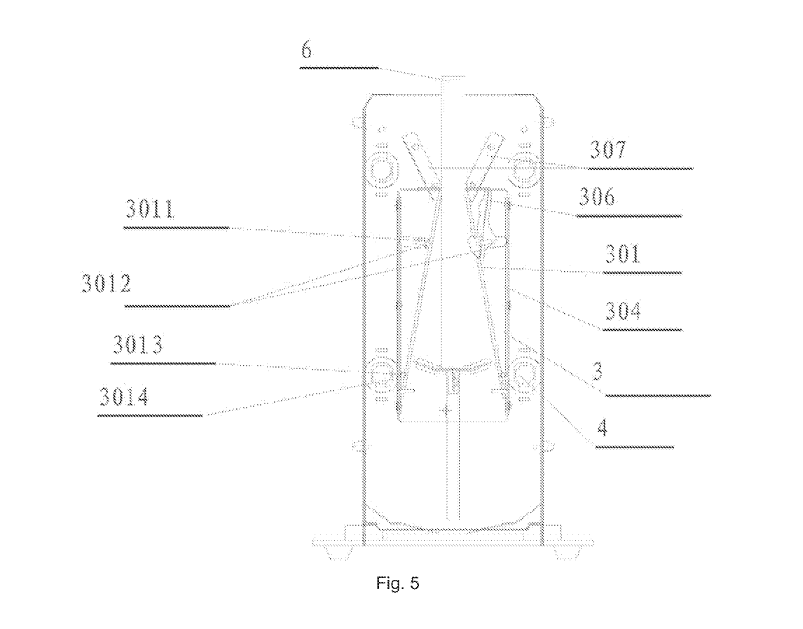

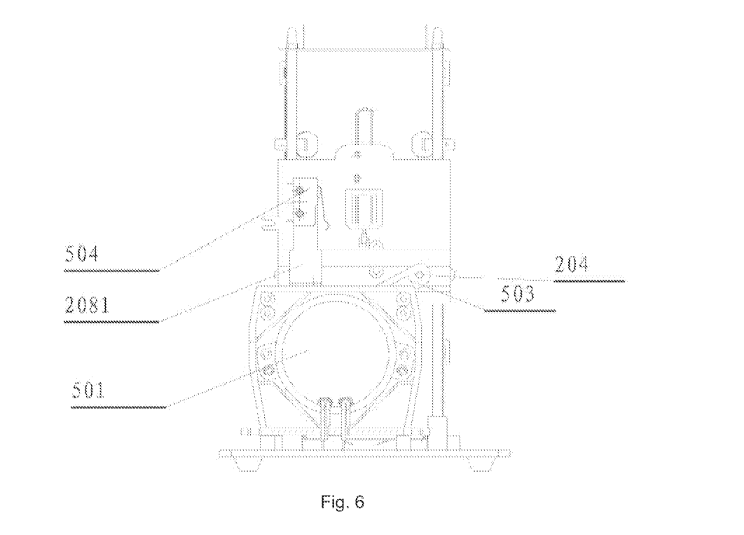

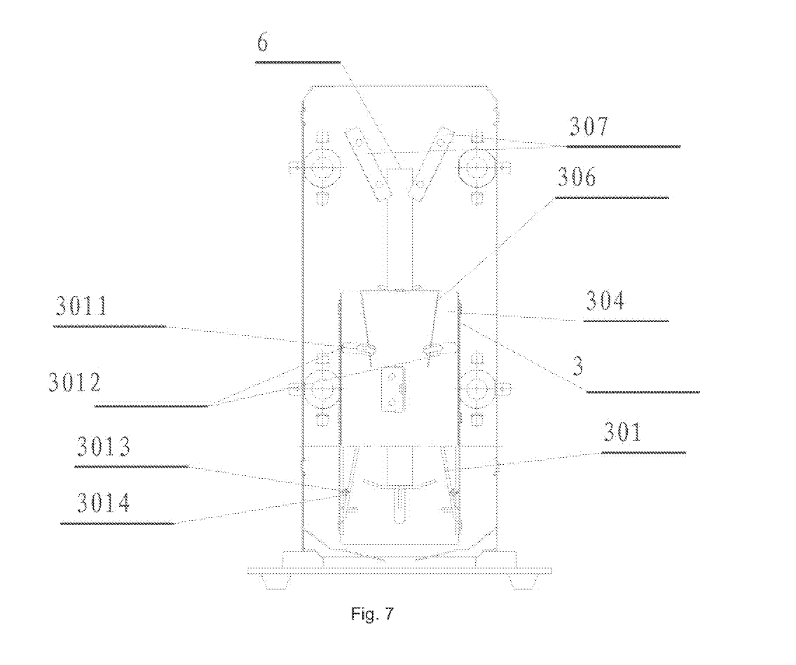

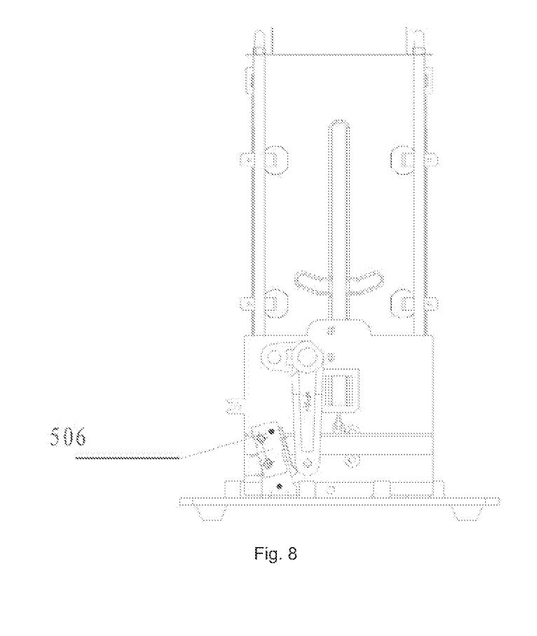

As illustrated in FIG. 1, FIG. 2 and FIG. 3, when the toaster is not in a working state, the sliding rack 201 and the toast rack 202 fixed onto the sliding rack 201 are at a highest position of the mechanism core assembly 1. Therefore, in this case, the isolation mesh frame assembly 3 is also at the highest position of the mechanism core assembly 1, and the isolation mesh 301 has been absolutely distracted by the inverted semi-cutaway angle steel 307. As such, the isolation mesh 301 is in a distraction state, facilitating placing and taking out of the bread. Under such circumstances, if a user needs to bake bread, the user places the bread into two isolation meshes of the toaster, and the bread may automatically move to the center of the two isolation meshes 301 under the action of gravity force. With a toasting temperature being suitably set for toasting the bread, after the “START” button is pressed, the quartz heating tube assembly 4 is powered on and starting heating, and the motor 501 simultaneously works. The trolley wheel 505 hinged onto the rocker arm 503 fixed onto the output shaft of the motor 501 is disposed in the guiding groove 204 on the front end face of the sliding rack 201, and the sliding rack 201 is at the highest position of the machine core. When the motor 501 starts rotating, in this embodiment, the motor 501 rotates clockwise, the rotation of the motor 501 drives the rocker arm 503 to rotate, and the trolley wheel 505 on the rocker arm 503 rolls along the guiding groove on the sliding rack 201. since the motor rotates clockwise, the trolley wheel 505 presses a lower flange of the guiding groove 204 on the sliding rack 201, to cause the sliding rack 201 to move downwards, such that the toast rack 202 and the isolation mesh frame assembly 3 that are fixed on the sliding rack 201 are driven to move downwards. As illustrated in FIG. 4, in this case, the isolation mesh horizontal bars 3011 on the isolation mesh 301 inside the isolation mesh frame assembly 3 gradually go distal from the inverted semi-cutaway angle steel 307. Under the action of the elastic force of the clamping spring 306, the isolation mesh 301 starts gradually folding. In this case, the bread 6 is gradually placed in the middle by the isolation mesh 301, and the toast rack 202 fixed on the sliding rack 201 carries the bread and continuously moves downwards. When the sliding rack 201 lowers down at a specific distance, under the action of the elastic force of the clamping spring 306, the isolation mesh 301 tightly clamps and holds the bread 6, as illustrated in FIG. 5 and FIG. 6. When the sliding rack 201 moves downwards to a lowest position of the mechanism core assembly 1, as illustrated in FIG. 7 and FIG. 8, the rocker arm 503 has rotated by nearly 180 degrees, and the trolley wheel 505 hinged onto the rocker arm 503 is in the guiding groove 204 and is at the lowest position of the mechanism core. In this case, the sliding rack 201 has moved downwards to the lowest position of the mechanism core. As such, a bump on the rocker arm 503 touches the lower limit switch 506, the control circuit detects that the lower limit switch 506 is closed, that is, the sliding rack 201 has reached the bottom of the mechanism core assembly 1, and the control circuit controls the motor 501 to stop rotation. According to program settings, the control circuit controls the motor 501 to rotate reversely, that is, the motor 501 rotates counterclockwise. The rotation of the motor 501 drives the rocker arm 503 to rotate, the trolley wheel 505 on the rocker arm 503 rolls along the guiding groove 204 on the sliding rack 201. Since the motor rotates counterclockwise, the trolley wheel 505 presses the upper flange of the guiding groove 204, to cause the sliding rack 201 to move upwards, such that the toast rack 202 and the isolation mesh frame assembly 3 that are fixed onto the sliding rack 201 are driven to move upwards. In this case, the sliding rack 201 starts moving upwards under driving of the motor 501, and the toast rack 202 and the isolation mesh frame assembly 3 that are fixed onto the sliding rack 201 drive the bread 6 to move upwards as well.

The control circuit performs timing for the rotation time of the motor 501, and controls the rotation time of the motor 501. When the rotation time of the motor 501 reaches a predetermined time, the sliding rack 201, the toast rack 202 and the isolation mesh frame assembly 3 that are fixed onto the sliding rack 201, and the bread 6 disposed inside the isolation mesh frame assembly 3 have moved upwards at a specific distance, as illustrated in FIG. 5 and FIG. 6. In this case, the control circuit controls the motor 501 to rotate counterclockwise, the sliding rack 201 starts moving downwards under the driving of the motor 501, and the sliding rack, the toast rack 202 and the isolation mesh frame assembly 3 that are fixed onto the sliding rack 201, and the bread 6 disposed inside the isolation mesh frame assembly 3 start moving downwards. The control circuit performs timing for the rotation time of the motor 501, and controls the rotation time of the motor 501. When the rotation time of the motor 501 reaches the predetermined time, the sliding rack 201, the toast rack 202 and the isolation mesh frame assembly 3 that are fixed onto the sliding rack 201, and the bread 6 disposed inside the isolation mesh frame assembly 3 have moved downwards at a specific distance. In this way, a whole toasting cycle is completed. Through experiment, several toasting cycles of upward and downward moving may be determined as a toasting color, and a plurality of bread toasting colors may be defined by setting different numbers of toasting cycles of toasting time and upward and downward moving for different bread toasting color levels. When toasting in the toaster reaches a time set by a user for a toasting color, the toasting cycle is completed. The control circuit controls the motor 501 to rotate towards the rising direction of the sliding rack 201, such that the sliding rack 201 starts moving downwards under the driving of the motor 501, and the toast rack 202 and the isolation mesh frame assembly 3 that are fixed onto the sliding rack 201 carry the bread 6 to move upwards as well. When the toast rack 202 and the isolation mesh frame assembly 3 that are fixed onto the sliding rack 201 carry the bread 6 to move upwards to a specific position, the isolation mesh horizontal bars 3011 on the isolation mesh 301 starts touching the inverted semi-cutaway angle steel 307 fixed on the inner side faces of the front side plate 105, the inverted semi-cutaway angle steel 307 slowly distracts the isolation mesh 301, and when the rocker arm 503 rotates to the highest position and stops rotating after touching the upper limit switch 209. In this case, the sliding rack 201, the toast rack 202 and the isolation mesh frame assembly 3 that are fixed onto the sliding rack 201 carry the bread 6 and move to the highest position, the baked bread slice has reached the top of the machine core, the inverted semi-cutaway angle steel 307 has completely distracted the isolation mesh 301, and the user may conveniently take out the baked bread.

A method for controlling a fast toasting toaster is provided, comprising the following steps:

A. configuring a toasting-color selection button in a control circuit, wherein toasting colors are set by using the number of clockwise and counterclockwise rotations of the motor as a cycle, or toasting-colors are distinguished based on several different cycles within an accomplishment time duration;

B. after the control circuit detects a start signal, performing initialization, and detecting a control signal and determining a toasting temperature set for the toaster by the control circuit;

C. controlling, by the control circuit, a heating tube to be powered on and start heating, whereupon the toaster enters a bread toasting state;

D. controlling, by the control circuit, a motor to clockwise rotate;

E. after the control circuit detects a close signal of a lower limit switch, controlling, by the control circuit, the motor to stop rotating, with a pause of half a second;

F. controlling, by the control circuit, the motor to counterclockwise rotate, and starting timing, with a pause of half a second when the motor rotates to a predetermined time;

G. controlling, by the control circuit, a motor to clockwise rotate;

H. determining, by the control circuit, whether the number of cycles defined for motor rotation of a set toasting color, or the accomplishment time is reached;

I. if the number of cycles of motor rotation is less than the number of cycles defined for a set toasting color or the accomplishment time is not reached, returning to step F; if the number of cycles of motor rotation is equal to the number of cycles defined for a set toasting color or the accomplishment time is reached, controlling, by the control circuit, the motor to counterclockwise rotate; and when the upper limit switch is closed, controlling, by the control circuit, the heating tube to stop heating, whereupon the motor stops rotating and the toasting cycle is terminated; and

L. if the control circuit detects a stop signal, controlling, by the control circuit, the motor to counterclockwise rotate; and when the upper limit switch is closed, controlling, by the control circuit, the heating tube to stop heating, whereupon the motor stops rotating and the toasting cycle is terminated.

The motor rotation direction herein may be defined according to actual needs. When the sliding rack is driven to move upwards, the motor rotates clockwise, and the motor rotates counterclockwise when the sliding rack is driven to move downwards. Optionally, the motor may rotate counterclockwise to drive the sliding rack to move upwards, and may rotate clockwise to drive the sliding rack to move downwards. The driving of the sliding rack may be implemented by adjusting the upper limit switch and the lower limit switch to be on the left side or the right side of the rocker arm of the output shaft of the motor. When the upper limit switch and the lower limit switch are on the left side of the rocker arm of the output shaft of the motor, the motor rotates counterclockwise to drive the sliding rack to move upwards, and rotates clockwise to drive the sliding rack to move downwards. When the upper limit switch and the lower limit switch are on the right side of the rocker arm of the output shaft of the motor, the motor rotates clockwise to drive the sliding rack to move upwards, and rotates counterclockwise to drive the sliding rack to move upwards.

When bread is to be baked:

(1) The power supply is connected, and the toasting color is set.

(2) The bread is placed into the bread toasting slot of the toaster, the START button is pressed, and the control circuit controls the quartz heating tube to start heating, the motor starts rotating clockwise, and the toaster enters a bread toasting working state.

(3) According to program settings, when the rocker arm of the motor rotates to the bottom and touches the lower limit switch, the rotation temporarily is suspended for half a second, and then the control circuit controls the motor to rotate counterclockwise; when the counterclockwise rotation reaches a predetermined time, the rotation is suspended for half a second, and then the control circuit further controls the motor to rotate reversely. As such, the sliding rack, the toast rack and the isolation mesh frame that are fixed onto the sliding rack carry the bread to repeatedly move upwards and downwards in the bread toasting slot subject to heating, until the working time for the set toasting color is reached.

(4) When the working time of the set toasting color is reached, the control circuit controls the quartz heating tube to stop heating. In this case, no matter which position the sliding rack is disposed in, the control circuit controls the motor to suspend for half a second, and then controls the motor to rotate reversely until the upper limit switch on the top portion is touched. Subsequently, the motor enters a standby state. In this way, a whole bread toasting cycle is completed, and the user may take out the bread.

(5) During the toasting course, the STOP button may also be pressed to interrupt the toasting.

According to the present invention, the power and the heating capacity may be improved, and fast bread toasting may be achieved, and the problem of uneven toasting of the bread may be solved. During the course of bread toasting, the bread slices are made to move at a specific distance, such that these bread slices are evenly and uniformly heated. In this way, fast toasting and uniform and even toasting of the bread may be achieved.

1. A fast toasting toaster, comprising a machine core assembly, a sliding rack assembly, a healing tube assembly, and a housing fixed onto a base, the mechanism core assembly comprising a front side plate, a side plate, and a rear side plate, the front side plate, the side plate and the rear side plate being fixed and coupled to form the machine core and then being fixed onto the base, the heating tube assembly being fixed onto the front side plate and the rear side plate and being positioned between the front side plate and the rear side plate, the sliding rack assembly comprising a sliding rack and a toast rack fixed onto the sliding rack, characterized in that: a drive assembly is arranged, the drive assembly comprising a motor and a drive mechanism, the motor driving the sliding rack assembly to move upwards and downwards through the driving mechanism.

2. The fast toasting toaster according to claim 1, characterized in that: an isolation mesh frame assembly is fixed onto the sliding rack; the toast rack is positioned in the isolation mesh frame assembly; the sliding rack is positioned on an outer side of the front side plate of the machine core assembly; and the toast rack and the insulation mesh frame assembly are positioned in a bread toasting slot of the machine core assembly, wherein the isolation mesh frame assembly comprises an isolation mesh, a clamping spring, and an inverted semi-cutaway angle steel, the isolation mesh and the clamping spring being arranged in the mesh frame, the inverted semi-cutaway angle steel for guiding the isolation mesh being fixed onto an inner side face of the front side plate.

3. The fast toasting toaster according to claim 2, characterized in that: the heating tube assembly comprises a heating tube bracket and a heating tube, the healing tube being respectively fixed onto the front side plate and the rear side plate through the healing tube bracket and being positioned between the front side plate and the rear side plate and on two sides of the roast rack and the isolation mesh frame assembly fixed onto the sliding rack.

4. The fast toasting toaster according to claim 3, characterized in that: a frame of the isolation mesh frame assembly is formed through fixing and coupling of a front clamping plate, a side clamping plate and a rear clamping plate; the isolation mesh frame assembly is fixedly coupled to the sliding rack through a top-bottom coupling plate; and the isolation mesh is positioned in the mesh frame and is movably coupled to the mesh frame.

5. The fast toasting toaster according to claim 4, characterized in that: upper portions of the front damping plate and the rear clamping plate are respectively provided with a guiding groove of the isolation mesh, two ends of an isolation mesh upper horizontal bar being respectively positioned in the guiding groove; and lower portions of the front clamping plate and the rear clamping plate are respectively provided with an isolation mesh hole, two ends of an isolation lower horizontal bar being respectively positioned in the isolation mesh hole; a lower middle portion of the side clamping plate is further provided with an isolation mesh limiting pad, the limiting pad being provided with a limiting hole; and a vertical steel rope at the center of the isolation mesh is inserted into the limiting hole.

6. The fast toasting toaster according to claim 5, characterized in that: an inverted U-shaped damping spring is fixed onto an upper flanging of the front clamping plate, two downwardly extended legs of the inverted U-shaped damping spring respectively abutting against outer sides of the isolation mesh upper horizontal bar.

7. The fast toasting toaster according to claim 6, characterized in that: an end of the front clamping plate from which the isolation mesh upper horizontal bar extends corresponds to an upright-side outer side vertical direction of the inverted semi-cutaway angle steel in terms of position.

8. The fast toasting toaster according to claim 7, characterized in that: an upright shaft support is fixed onto a front end of the machine core assembly; an upright shaft is fixed between the upright shaft support and the base; the sliding rack is slidably coupled to the upright shaft; and a front end face of the sliding rack is provided with a guiding groove.

9. The fast toasting toaster according to claim 8, characterized in that: the drive assembly further comprises a motor stand, a lower limit switch, an upper limit switch and the motor that are fixed onto the motor stand; the drive mechanism comprises a rocker arm and a trolley wheel; the rocker arm is fixed onto an output shaft of the motor; the trolley wheel is hinged to the rocker arm; the trolley wheel is positioned in the guiding groove arranged on the front end face of the sliding rack and slidably coupled to the sliding rack; and the motor stand is fixed onto the base.

10. A method for controlling a fast toasting roaster, characterized by comprising the following steps:
A. configuring a toasting color selection button in a control circuit, wherein toasting colors are set by using the number of clockwise and counterclockwise rotations of the motor as a cycle, or toasting colors are distinguished based on several different cycles within an accomplishment time duration;
B. after the control circuit detects a start signal, performing initialization, and detecting a control signal and determining a toasting color set for the toaster by the control circuit;
C. controlling, by the control circuit, a heating tube to be powered on and start heating, whereupon the toaster enters a bread toasting state;
D. controlling, by the control circuit, a motor to clockwise rotate;
E. after the control circuit detects a close signal of a lower limit switch, controlling, by the control circuit, the motor to stop rotating, with a pause of half a second;
F. controlling, by the control circuit, the motor to counterclockwise rotate, and starting timing, with a pause of half a second when the motor rotates to a predetermined time;
G. controlling, by the control circuit, a motor to clockwise rotate;
H. determining, by the control circuit, whether the number of cycles defined for motor rotation of a set toasting color or the accomplishment time is reached;
I. if the number of cycles of motor rotation is less than the number of cycles defined for a set toasting color or the accomplishment time is not reached, returning to step F; if the number of cycles of motor rotation is equal to the number of cycles defined for a set toasting color or the accomplishment time is reached, controlling, by the control circuit, the motor to counterclockwise rotate; and when the upper limit switch is dosed, controlling, by the control circuit, the heating tube to stop heating, whereupon the motor stops rotating and the toasting cycle is terminated; and
L. if the control circuit detects a stop signal, controlling, by the control circuit, the motor to counterclockwise rotate; and when the upper limit switch is closed, controlling, by the control circuit, the heating tube to stop heating, whereupon the motor stops rotating and the toasting cycle is terminated.
